(19) United States
(12) Patent Application Publication
(10) Pub. No.: US 2026/0118823 A1
(43) Pub. Date: Apr. 30, 2026

(54) LOCKING MOBILE FOR AN ESCAPEMENT DEVICE OF A TIMEPIECE

(71) Applicant: Rolex SA, Genève 26 (CH)

(72) Inventors: Fabiano COLPO, Lausanne (CH); Olivier KARLEN, Blonay (CH)

(21) Appl. No.: 19/376,822

(22) Filed: Oct. 31, 2025

(30) Foreign Application Priority Data
Oct. 31, 2024 (EP) 24210158.2

(51) Int. Cl. G04B 15/14

(52) U.S. Cl. CPC G04B 15/14

(57) ABSTRACT

A locking mobile of an escapement device of a timepiece, comprising a fork with two first portions, the so-called impulse portions, facing one another and arranged to transmit to an inertial element, during an impulse phase, at least a part of an impulse received from at least one escapement mobile,

characterized in that the fork comprises two second portions, the so-called abutment portions, facing one another and each arranged to project with respect to one of the first portions and each arranged to come into abutment with the inertial element, if a shock is received by the movement of the timepiece during the resting phase.

### CROSS-REFERENCE TO RELATED APPLICATIONS

The present application claims priority to European Application No. 24210158.2 filed with the European Patent Office on Oct. 31, 2024, which is incorporated herein by reference in its entirety for all purposes.

### TECHNICAL FIELD OF THE INVENTION

This invention generally relates to escapement devices of a movement of a timepiece, and the invention in particular relates to a locking mobile for such escapement devices.

### PRIOR ART

In the prior art of escapement devices, the document CH44855A or the document EP3754433A1 are known, which disclose anchor escapements, with an anchor devoid of a dart and the fork of which makes provision for an anti-overbanking safety by interacting with the balance plate. On the other hand, these systems are bulky, particularly due to the dimensions of the anchor, which must be of significant length to ensure that the fork has sufficient amplitude of displacement to engage with and disengage from the impulse pin, even with the small angular deflection of the anchor inherent to these types of escapement. Furthermore, it may be noted that these escapements of Swiss anchor type are of necessity sensitive to friction during the impulse phase, since the anchor and the escapement wheel pivot in the same direction of rotation during this impulse phase.

### SUMMARY OF THE INVENTION

One aim of this invention is to meet the drawbacks of the prior art mentioned above and in particular, first of all, to make provision for an escapement device with components which make it possible to improve the known escapement devices, i.e. have an effective operation, and/or have good efficiency, and/or have a good operational safety, and/or have good shock resistance, and/or reduce the overall bulk.

To do so, a first aspect of the invention relates to a locking mobile for a movement of a timepiece, the timepiece movement comprising:
an escapement device comprising the locking mobile and at least one escapement mobile,
an oscillator comprising at least one inertial element equipped with a driving portion such as a tooth or a pin, and elastic return means (e.g. a spring, a spiral spring, a hairspring or the like) coupled to the inertial element, the locking mobile comprising:
locking means or locking surfaces, arranged to lock, during a resting phase, said at least one escapement mobile of the escapement device,
impulse-receiving means or impulse-receiving surfaces, arranged to receive, during an impulse phase, an impulse from said at least one escapement mobile,
a fork with two first portions, the so-called impulse portions, facing one another and arranged to transmit to the driving portion of the inertial element, during the impulse phase, at least a part of the impulse received from said at least one escapement mobile, characterized in that the fork comprises two second portions, the so-called abutment portions, facing one another and each arranged to project with respect to one of the first portions, and each arranged to come into abutment with the inertial element, if a shock is received by the movement of the timepiece during the resting phase.

The locking mobile according to the implementation above comprises a fork which interacts with the driving portion of the inertial element and this fork comprises, to project with respect to the impulse portions (which can also be known as surface impulse portions or impulse surfaces), second portions, the so-called abutment portions. These second projecting portions form bosses or protrusions from the first portions. Such second projecting portions make it possible to make provision for an abutting with the inertial element, even if the locking mobile is of compact dimensions and/or has significant angular deflections between two successive resting positions, as can be the case for an escapement with a tangential drive for example.

The locking mobile can be defined by the following features, taken individually or in combination.

According to an embodiment, the fork comprises two horns each elongated along, respectively, a longitudinal horn direction, and each horn, along a direction transverse to the respective longitudinal horn direction, has:
a first width E1 at the level of the first portion,
a second width E2 at the level of the second portion,
   and wherein E2>E1, preferably E2>1.1.E1, preferably E2>1.2.E1, preferably E2>1.3.E1. According to this configuration, the horns have a transverse dimension (with respect to their longitudinal direction) which increases when one passes from the first portions to the second portions. According to an embodiment, each second portion is projecting or protruding toward the inside of the fork. In other words, each second projecting portion can optionally cause a reduction in the width of the opening of the fork separating two horns, or may cause a reduction in a flare of the width of the opening of the fork separating two horns, typically known in the prior art.

According to an embodiment, each of the second portion comprises at least:
a distal abutment end, formed at a free end of the fork, in particular at a free end of the horn of the fork,
a radial surface, basically oriented along a direction normal to a pivoting direction of the locking mobile,
   wherein:
the distal abutment end is arranged to come into abutment with the inertial element if a shock is applied to the movement of the timepiece during the travel of an additional ascending or descending angle by the inertial element, preferably during the travel of an additional ascending or descending angle by the inertial element during which the driving portion is not in the phase of engagement with or disengagement from the fork,
   and/or
the radial surface is arranged to come into abutment with the driving portion of the inertial element if a shock is applied to the movement of the timepiece during the travel of an additional ascending or descending angle by the inertial element, preferably during the travel of an additional ascending or descending angle by the inertial element during which the driving portion is in the phase of engagement with or disengagement from the fork. According to this implementation, two functional parts may be distinguished on each second portion. A first functional part is a distal or end part which can abut the inertial element (and not the driving portion) if a shock is received while the driving portion of the inertial element is disengaged from the fork. A second functional part is a radial or lateral or internal part, located between the first functional part and the first portion, and which can abut the driving portion of the inertial element if a shock is received while the driving portion of the inertial element is in the process of engagement with or disengagement from the fork.

According to an embodiment, each first portion is connected to a second portion by a third portion, the so-called connecting portion, with preferably a reversal of the gradient or slope and/or a recess arranged at the third portion. In particular, at the level of the third portion, the so-called connecting portion, provision may be made for a change of sign of the derivative (i.e. one has an inflection point or a local extremum), or a change of direction of the gradient when passing from the first portion to the second portion. According to an embodiment, each first portion is adjacent to a second portion, and the transition between each first portion and the respective second portion forms or defines the third portion.

According to an embodiment, a first tangent line to a first portion forms with a second tangent line to the second portion arranged to project from said first portion an angle δ of less than 180° when said first portion and said second projecting portion are viewed from the inside of the fork. In particular, the first tangent line may be tangent to the first portion at the level of the intersection point of the second tangent line with the first portion. More particularly, a plane of symmetry of the fork may be defined, and the second tangent line may be parallel or substantially parallel to the plane of symmetry of the fork.

According to an embodiment, each first portion comprises, preferably moving away from an axis of rotation of the locking mobile, at least one planar surface and at least one curved surface. Preferably, said at least one curved surface may comprise a surface of circular or of an arc of circle section or a circular or an arc of circle profile.

According to an embodiment, each second portion comprises at least one curved surface. According to an embodiment, each second portion comprises a surface of circular or of an arc of circle section or a circular or an arc of circle profile.

According to an embodiment:
the locking means and/or the impulse-receiving means are arranged at a radial distance R41 from an axis of rotation of the locking mobile,
the second portions, the so-called abutment portions, are arranged at a radial distance R4 from the axis of rotation of the locking mobile,
   wherein R4>R41, preferably R4>1.4.R41, preferably R4>1.8.R41.

In particular, the radial distance R41 is between:
a first radial distance Ra41 from an axis of rotation of the locking mobile, from which extend the impulse-receiving means, and
a second radial distance Ra43 from an axis of rotation of the locking mobile, at which are arranged a terminal end of the locking means.

According to an embodiment, the locking mobile is characterized:
in that it is planar or formed by a planar component, and/or
in that it is devoid of a dart, and/or
in that it is made as a single part or formed by an assembly of at least two components,
in that it may be made of silicon and manufactured by etching into a wafer, or in that it may be manufactured by metallic growth in an electrotyping mold, or in that it may be manufactured by conventional cutting-out of a metal plate, or in that it may be manufactured out of metallic glass or out of an amorphous material,
in that it may be devoid of attached pallets.

According to an embodiment, the impulse-receiving means are arranged to receive a tangential impulse from said at least one escapement mobile.

According to an embodiment, the locking mobile is symmetrical or substantially symmetrical with respect to a midplane, passing between the two horns or through the opening separating two horns and through the axis of rotation of the locking mobile.

According to an embodiment, the locking mobile is arranged to interact with two escapement mobiles.

A second aspect may pertain to a regulator device for a movement of a timepiece, comprising:
an escapement device comprising a locking mobile according to the first aspect and at least one escapement mobile arranged to be engaged with a gear train of the timepiece, such as a driving gear train, to receive a driving force,
an oscillator comprising an inertial element equipped with a driving portion such as a tooth or a pin, and elastic return means coupled to the inertial element,
two outer abutments, formed for example by banking pins or by detent pins or abutment walls,
   wherein, during the resting phase, the fork of the locking mobile is arranged to come into abutment with one of the two outer abutments and the driving portion in the event of a knock or knocking of the oscillator, a first horn of the fork is arranged to come into abutment with the driving portion, and a second horn of the fork is arranged to come into abutment with one of the two outer abutments.

According to an embodiment, a triangle having as apices the axis of rotation of the locking mobile, the axis of rotation of the first escapement mobile and the axis of rotation of the second escapement mobile, has, at the apex centered on the axis of rotation of the locking mobile, an angle less than 120°, preferably an angle less than 90°, preferably an angle less than 80°. According to an embodiment, the locking mobile is not arranged between the axis of rotation of the first escapement mobile and the axis of rotation of the second escapement mobile. According to an embodiment, the axis of rotation of the locking mobile is contained in a triangle, the apices of which are respectively the axes of rotation of the escapement mobiles and the axis of rotation of the oscillator. According to an embodiment, it is possible to identify a circle centered on the axis of rotation of the locking mobile and passing through the axis of rotation of the first escapement mobile and through the axis of rotation of the second escapement mobile, and which passes through at least one portion of the oscillator or of the balance. According to an embodiment, the locking mobile does not have an elongated or highly elongated shape, with typically a length of the locking mobile less than twice the maximum width of the locking mobile. According to an embodiment, a part of the locking mobile the furthest from its center of rotation is arranged at a radius substantially equal to a maximum width of the locking mobile: the general shape of the locking mobile is compact and uniform (with no notable excrescences), which limits its moment of inertia (strongly influenced by the square of the distance to the axis of rotation).

According to an embodiment, the escapement device is not of direct impulse type. In other words, said at least one escapement mobile never directly interacts with the inertial element. According to an embodiment, the locking mobile is the only member of the escapement device which interacts directly with the inertial element. According to an embodiment, the locking mobile forms a single member of the escapement device arranged between said at least one escapement mobile and the inertial element, from the operational point of view.

The second aspect may pertain to a regulator device for a movement of a timepiece, comprising:
an escapement device comprising a locking mobile according to the first aspect and at least one escapement mobile arranged to be engaged with a gear train of the timepiece movement, such as a driving gear train, to receive a driving force,
an oscillator comprising an inertial element equipped with a driving portion such as a tooth or a pin, and elastic return means coupled to the inertial element,
   wherein the locking mobile is mounted pivotably and has between two successive resting positions a rocking movement of an amplitude greater than 30°, preferably greater than 40°, preferably greater than 45°. In such an escapement device. the impulse is typically tangential. In other words, during the impulse, the locking mobile and the escapement mobile that transmits the impulse pivot in opposite directions of rotation. The sensitivity to friction is thus reduced.

According to an embodiment, the escapement device comprises:
a first escapement mobile, mounted pivotably about a first axis of rotation, arranged to be engaged with the gear train of the timepiece movement, and comprising a plurality of first locking surfaces to interact with the locking means of the locking mobile and a first driving toothset,
a second escapement mobile, mounted pivotably about a second axis of rotation, comprising a plurality of second locking surfaces to interact with the locking means of the locking mobile and a second driving toothset engaged with the first driving toothset to transmit the driving force of the first escapement mobile to the second escapement mobile.

According to an embodiment, during an impulse phase given by the first escapement mobile to the locking mobile, the impulse is tangential. According to an embodiment, during an impulse phase given by the second escapement mobile to the locking mobile, the impulse is tangential. According to an embodiment, the impulse phase given by the first escapement mobile to the locking mobile is carried out during a first alternation of an oscillation, and the impulse phase given by the second escapement mobile to the locking mobile is carried out during a second alternation of said oscillation.

According to an embodiment:
the driving portion is arranged at a radial distance R5 from the axis of rotation of the inertial element,
the second portions, the so-called abutment portions, are arranged at a radial distance R4 from the axis of rotation of the locking mobile,
   wherein 0.8.R5<R4<1.2.R5 and preferably 0.9.R5<R4<1.1.R5. According to this implementation, the locking mobile is significantly more compact than an anchor of an escapement device with a Swiss anchor.

According to an embodiment:
the driving portion has a half-moon shape, and/or
the inertial element comprises a cylindrical lateral surface forming an abutment wall arranged to come into abutment with one of the two second portions, the so-called abutment portions, if a shock is received by the movement of the timepiece during the resting phase,
   wherein:
the driving portion is arranged at a radial distance R5 from the axis of rotation of the inertial element wherein,
the abutment wall is arranged at a radial distance R6 from the axis of rotation of the inertial element,
   wherein preferably R5>R6, preferably R5>1.2.R6, preferably R5>1.3.R6.

A third aspect may relate to a timepiece, comprising a regulator device according to the second aspect.

A fourth aspect of the invention, which can be independent or combined with the aspects above, relates to an escapement device for a timepiece movement, comprising:
a first escapement mobile, mounted pivotably about a first axis of rotation, arranged to be engaged with a gear train of the timepiece movement, such as a driving gear train, to receive a driving force, and comprising a plurality of first locking surfaces and a first driving toothset,
a second escapement mobile, mounted pivotably about a second axis of rotation, comprising a plurality of second locking surfaces and a second driving toothset engaged with the first driving toothset to transmit the driving force from the first escapement mobile to the second escapement mobile,
an inertial element, mounted pivotably about a third axis of rotation, arranged to have oscillations each comprising a first alternation and a second alternation,
a locking mobile, mounted pivotably about a fourth axis of rotation, comprising:
   a first surface locking portion, arranged to come into contact with one of the plurality of the first locking surfaces to lock the rotation of the first escapement mobile,
   a second surface locking portion, arranged to come into contact with one of the plurality of the second locking surfaces to lock the rotation of the second escapement mobile,
   impulse-receiving means, arranged to receive a first impulse from the first escapement mobile during a first alternation of an oscillation of the inertial element, and to receive a second impulse from the second escapement mobile during a second alternation of said oscillation of the inertial element,
   impulse-transmitting means, arranged to transmit at least a part of the first impulse or of the second impulse to the inertial element.

According to an embodiment, the first surface locking portion is arranged so that a first force, exerted on the locking mobile by the first escapement mobile locked by the first surface locking portion, passes substantially in the vicinity of the fourth axis of rotation, in particular passes through the fourth axis of rotation.

According to an embodiment, the second surface locking portion is arranged so that a second force, exerted on the locking mobile by the second escapement mobile locked by the second surface locking portion, passes substantially in the vicinity of the fourth axis of rotation, in particular passes through the fourth axis of rotation.

According to an embodiment, the first escapement mobile and/or the second escapement mobile may be a monoplanar component, made as a single part, monobloc or made of one material. According to an embodiment, the plurality of first locking surfaces and the first driving toothset may be arranged on one and the same plane. According to an embodiment, the plurality of second locking surfaces and the second driving toothset may be arranged on one and the same plane.

According to an embodiment, the first escapement mobile and/or the second escapement mobile may be a biplanar component, formed for example by two separate wheels, or for example by a multilevel component. According to an embodiment, the plurality of first locking surfaces and the first driving toothset may be arranged on two different planes. According to an embodiment, the plurality of second locking surfaces and the second driving toothset may be arranged on two different planes.

The escapement device according to the implementation above procures increased operational safety, since the first or the second locking force passes through the fourth axis of rotation or substantially through the fourth axis of rotation: in the locking position (or in the resting phase), the locking mobile does not undergo any rocking torque, which makes it possible to obtain a stable locking position.

It may be noted that the escapement device according to the implementation above transmits two impulses to the inertial element during one and the same oscillation (an outward and return journey) of the inertial element, to sustain its oscillations. Specifically, the locking mobile can:
receive from the first escapement mobile a first impulse and transmit it to the inertial element during a first alternation (for example an outward journey constituting a first half of an oscillation) of the inertial element, and
can receive from the second escapement mobile a second impulse and transmit it to the inertial element during a second alternation (for example a return journey constituting a second half of the oscillation under consideration) of the inertial element.

According to an embodiment, the first force, exerted on the locking mobile by the first escapement mobile locked by a first surface locking portion, passes substantially in the vicinity of the fourth axis of rotation, in particular passes through the fourth axis of rotation, such as to guarantee an absence of rocking torque on the locking mobile during a resting phase. In other words, the first force, exerted on the locking mobile by the first escapement mobile locked by a first surface locking portion, passes substantially in the vicinity of the fourth axis of rotation, in particular passes through the fourth axe of rotation, such as to guarantee a stable resting position of the locking mobile during a resting phase. In said resting phase, the locking mobile is only engaged with the first escapement mobile.

According to an embodiment, the second force, exerted on the locking mobile by the second escapement mobile locked by a second surface locking portion, passes substantially in the vicinity of the fourth axis of rotation, in particular passes through the fourth axis of rotation, such as to guarantee an absence of rocking torque on the locking mobile during a resting phase. In other words, the second force, exerted on the locking mobile by the second escapement mobile locked by a second surface locking portion, passes substantially in the vicinity of the fourth axis of rotation, such as to guarantee a stable resting position of the locking mobile during a resting phase. In said resting phase, the locking mobile is only engaged with the second escapement mobile.

According to an embodiment, the locking mobile is mounted in free pivot connection. According to an embodiment, the locking mobile is mounted in free pivot connection on a bridge and/or on a plate of the timepiece. According to an embodiment, the locking mobile is free of any elastic return device, and/or the escapement device is free of any elastic return device coupled to or engaged with the locking mobile to retain it or return it into a resting position (it being understood that this does not preclude the elastic member (conventionally a spiral) of the oscillator coupled to the inertial element from causing, by way of the sustained movements of the inertial element, the disengagement of the escapement mobiles and then the movements of the locking mobile). In other words, the displacements of the locking mobile are caused by the inertial element and/or the first escapement mobile and/or the second escapement mobile. In particular, during the normal operation of the escapement device, the displacements of the locking mobile are exclusively caused by the inertial element and/or the first escapement mobile and/or the second escapement mobile.

According to an embodiment, the escapement device is not a direct impulse escapement device. In other words, according to this embodiment, the first escapement mobile and/or the second escapement mobile do not interact directly with the inertial element (or a member of the oscillator typically formed by a balance/spiral pair).

According to an embodiment, the inertial element comprises a balance. In particular, the inertial element may comprise a balance, a balance shaft and a plate with a pin, coupled to a spiral spring.

According to an embodiment, the first surface locking portion is arranged to lock the rotation of the first escapement mobile, i.e. an escapement movement of the first escapement mobile, and/or the second surface locking portion is arranged to lock the rotation of the second escapement mobile, i.e. an escapement movement of the second escapement mobile.

According to an embodiment, the first surface locking portion is arranged so that a first friction cone constructed around a point of application of the force exerted by the first escapement mobile on the locking mobile comprises, or encompasses, or passes through the fourth axis of rotation, and/or the second surface locking portion is arranged so that a second friction cone constructed around a point of application of the force exerted by the second escapement mobile on the locking mobile comprises, or encompasses, or passes through the fourth axis of rotation.

According to an embodiment, the first surface locking portion has a first normal direction passing through the fourth axis of rotation or passing substantially through the fourth axis of rotation, and the second surface locking portion has a second normal direction passing through the fourth axis of rotation or passing substantially through the fourth axis of rotation.

According to an embodiment:
a first line passing through the fourth axis of rotation and through a point of contact between the first escapement mobile and the first surface locking portion during a first locking phase, and
a second line passing through the fourth axis of rotation and through a point of contact between the second escapement mobile and the second surface locking portion during a second locking phase,
   define with one another an acute angle α. In other words, one may construct a triangle having:
as first apex, the fourth axis of rotation,
as second apex, the point of contact between the first escapement mobile and the first surface locking portion,
as third apex, the point of contact between the second escapement mobile and the second surface locking portion. According to the embodiment above, this triangle has an acute angle at the level of its first apex. Such a configuration makes it possible to guarantee a reduced track for the locking mobile between a first locking position (of the locking mobile) in which the first escapement mobile is locked (by the locking mobile) and a second locking position (of the locking mobile) in which the second escapement mobile is locked (by the locking mobile). This procures a compact and advantageously symmetrical assembly by comparison with a plane passing through the respective axes of rotation of the inertial element and of the locking mobile.

According to an embodiment, the impulse-receiving means of the locking mobile comprise:
a first impulse input portion, arranged to receive the first impulse of the first escapement mobile during the first alternation of the balance,
a second impulse input portion, arranged to receive the second impulse of the second escapement mobile during the second alternation of the balance.

According to an embodiment, the first impulse input portion is adjacent to the first surface locking portion, and the second impulse input portion is adjacent to the second surface locking portion.

According to an embodiment, the first impulse input portion is separated from the first surface locking portion by a first resting tip, and the second impulse input portion is separated from the second surface locking portion by a second resting tip.

According to an embodiment:
a third line passing through the fourth axis of rotation and through a point of contact between the first escapement mobile and the first impulse input portion during a first impulse phase, and
a fourth line passing through the fourth axis of rotation and through a point of contact between the second escapement mobile and the second impulse input portion during a second impulse phase, define with one another an acute angle γ.

According to an embodiment, the angle γ is included in a range of values ranging from 50° to 70°.

According to an embodiment, the angle γ is less than the angle α. In other words, the first and second impulse input portions are arranged between the first and second surface locking portions.

According to an alternative embodiment, the angle γ may be greater than the angle α. In other words, the first and second surface locking portions are arranged between the first and second impulse input portions. Such an implementation may make it possible to symmetrically distribute the displacements caused by any clearances in the escapement mobiles on their respective axes of rotation.

### DESCRIPTION OF THE FIGURES

Other features and advantages of this invention will become more clearly apparent on reading the following detailed description of embodiment(s) of the invention given by way of in no way limiting example(s) and illustrated by the appended drawings, wherein:

FIG. 1 shows a regulator device for a movement of a timepiece, comprising on the one hand an escapement device comprising a locking mobile, a first escapement mobile and a second escapement mobile and on the other hand an oscillator comprising an inertial element equipped with a driving portion;

FIG. 2 shows in detail the locking mobile of the regulator device of FIG. 1;

FIG. 3 shows in detail a fork of the locking mobile of FIG. 2;

FIG. 4 shows other aspects of the fork of the locking mobile of FIG. 2;

FIG. 5 shows the regulator device of FIG. 1, during a resting phase of the escapement device, following a shock leading the locking mobile to perform an angular rotation along a first direction S1;

FIG. 6 shows the regulator device of FIG. 1, during a resting phase of the escapement device, following a shock leading the locking mobile to perform an angular rotation along a second direction S2;

FIG. 7 shows a fictitious regulator device in the same configuration as that shown in FIG. 6, and comprising a fictitious locking mobile;

FIG. 8 shows the regulator device of FIG. 6, to show the shake of the locking mobile, particularly at the level of the horns of the locking mobile;

FIG. 9 shows the regulator device of FIG. 1, during a knock of the oscillator while the escapement device is in the resting phase;

FIG. 10 shows a detail of the regulator device of FIG. 1 to show a total rocking angle of the locking mobile occupying two successive resting positions;

FIG. 11 shows a very simplified fork of a first variant embodiment of the locking mobile and in particular of the fork of the locking mobile of the regulator device of FIG. 1;

FIG. 12 shows a very simplified fork of a second variant embodiment of the locking mobile and in particular of the fork of the locking mobile of the regulator device of FIG. 1;

FIG. 13 shows a variant of the regulator device of FIG. 1, particularly comprising a third variant embodiment of the locking mobile of the regulator device of FIG. 1, during a resting phase of the escapement device;

FIG. 14 shows the regulator device of FIG. 13, during an impulse phase of the escapement device subsequent to the resting phase of FIG. 13;

FIG. 15 shows the regulator device of FIG. 13, during a resting phase of the escapement device subsequent to the impulse phase of FIG. 14;

FIG. 16 shows the regulator device of FIG. 13, during a resting phase of the escapement device subsequent to the resting phase of FIG. 15;

FIG. 17 shows in detail the locking mobile of the regulator device of FIG. 13;

FIG. 18 shows in detail the locking means and impulse-receiving means of the locking mobile of the regulator device of FIG. 13.

### DETAILED DESCRIPTION OF THE EMBODIMENT(S)

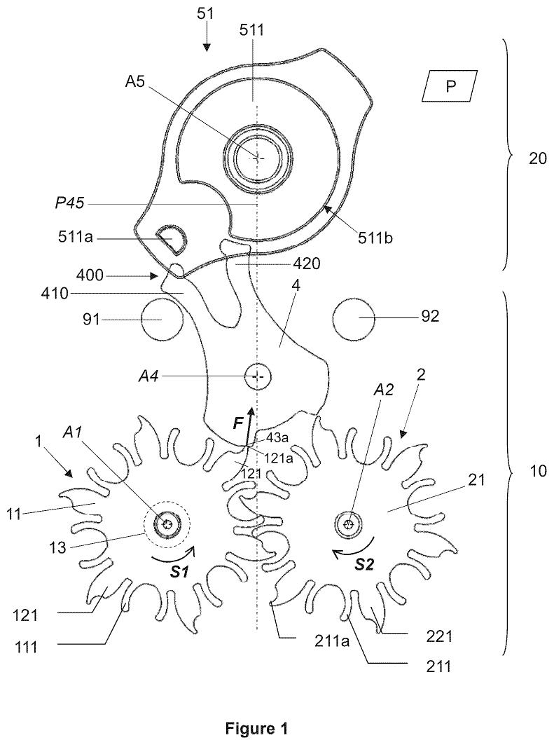

FIG. 1 shows a regulator device for a movement of a timepiece, comprising:
an escapement device 10 comprising a locking mobile 4, a first escapement mobile 1 and a second escapement mobile 2,
an oscillator 20 comprising an inertial element (here a balance 51) pivoting about a third axis of rotation A5 and equipped with a driving portion (here a pin 511a) positioned on a plate 511 of the balance 51, and an elastic return member (not shown) coupled to the balance 51 (provision can typically be made for a spiral spring, or flexible elements),
two outer abutments, formed in this example by banking pins 91 and 92, but provision could also be made for detent pins or abutment walls.

In the detail, the escapement device 10 comprises:
the first escapement mobile 1, mounted pivotably about a first axis of rotation A1, arranged to be engaged with the gear train of the timepiece movement via a pinion 13, and comprising a plurality of first locking surfaces 121a formed on first locking teeth 121 to interact with locking means of the locking mobile 4, and a first driving toothset 111,
the second escapement mobile 2, mounted pivotably about a second axis of rotation A2, comprising a plurality of second locking surfaces 221a formed on second locking teeth 221 to interact with the locking means of the locking mobile 4, and a second driving toothset 211 engaged with the first driving toothset 111 to transmit the driving force of the first escapement mobile 1 to the second escapement mobile 2,
the locking mobile 4 rotationally mobile about a fourth axis of rotation A4 and comprising:
   locking means, arranged to lock, during a resting phase, the first escapement mobile 1 or the second escapement mobile 2,
   impulse-receiving means, arranged to receive, during an impulse phase, an impulse from the first escapement mobile 1 or from the second escapement mobile 2,
   a fork 400 equipped with horns 410, 420.

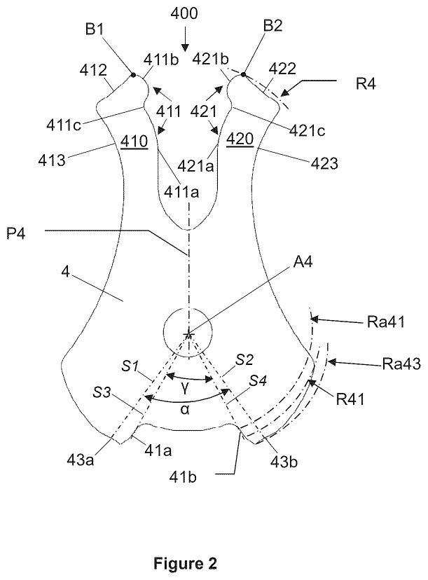

FIG. 2 shows in detail the locking mobile 4 of the regulator device of FIG. 1. The locking mobile 4 shown in FIG. 2 meanwhile comprises:
the locking means, formed in this example by first and second surface locking portions 43a, 43b, arranged to lock, during a resting phase, the first escapement mobile 1 or the second escapement mobile 2 via, respectively, one of the first locking surfaces 121a and one of the second locking surfaces 221a,
the impulse-receiving means formed in this example by a first impulse input portion 41a, arranged to receive a first impulse from the first escapement mobile 1 during a first alternation of the balance 51, and by a second impulse input portion 41b, arranged to receive a second impulse from the second escapement mobile 2 during a second alternation of the balance 51;
the fork 400 equipped with two horns 410, 420 each comprising an inner wall 411, 421 respectively equipped with:
   two first portions 411a, 421a the so-called impulse portions, facing one another and arranged to transmit to the pin 511a of the balance 51, during the impulse phase, at least a part of the received impulse,
   two second portions 411b, 421b, the so-called abutment portions, facing one another and each arranged to project with respect to one of the first portions 411a, 421a, and each arranged to come into abutment with an abutment wall 511b of the plate 511, if a shock is received by the movement of the timepiece during the resting phase. It will be understood that during the normal operation of the escapement device 10 (particularly in the absence of any shock), only the two first portions 411a, 421a contact or interact with the pin 511a. During this normal operation, the second portions 411b, 421b do not interact, either with the pin 511a, or with the plate of the balance 511.

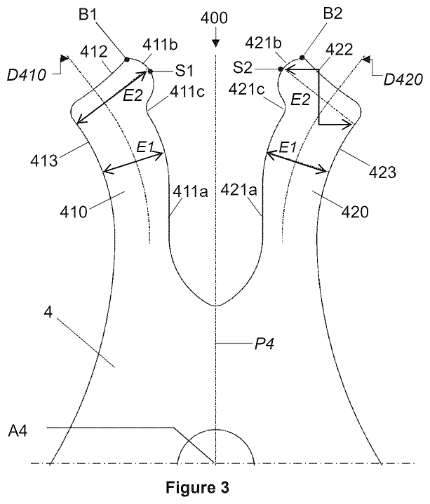

In more detail, and as can be seen in FIGS. 2, 3 and 4, each horn 410, 420 comprises an inner wall 411, 421 equipped with:
a first portion 411a, 421a, the so-called impulse portion, formed from the base of the fork, which is intended to interact with the pin 511a of the plate 511 of the balance 51,
a second portion 411b, 421b, the so-called abutment portion, opening out at the free end of each of the horns, the end B1, B2 of which forms a means, in particular a line or an edge or a surface, for abutment, intended to optionally interact with the wall 511b of the plate 511. The first and second portions may in particular be attached by a third portion 411c, 421c, the so-called connecting portion, so that the second portion is in the extension of the first portion.

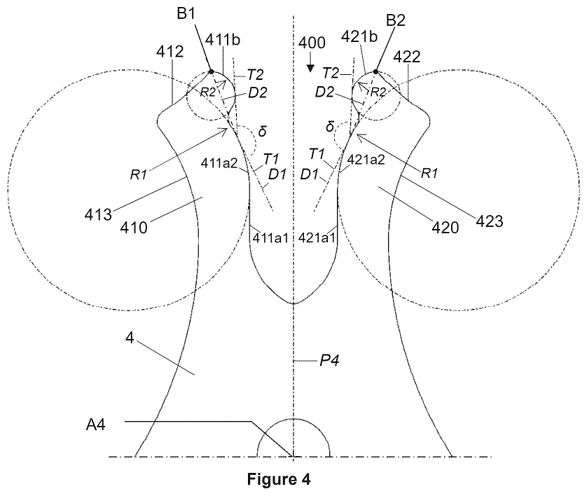

Note that the first impulse portion 411a, 421a may take the form of a single planar or curved surface, or else be composed of several continuous or discontinuous surfaces. In a variant embodiment shown in FIG. 4, this first impulse portion 411a, 421a is in particular composed of a first planar surface 411a1, 421a1 and a second curved surface 411a2, 421a2 (of an arc of circle shape) equipped with a radius of curvature R1, this second surface being formed in the extension of the first surface.

The second portion 411b, 421b can take the form of a single planar or curved surface, or else be composed of several continuous or discontinuous surfaces. In a variant embodiment shown in FIGS. 2 to 4, this second portion 411b, 421b takes the form of a single curved surface 411b, 421b (of an arc of circle shape) provided with a radius of curvature R2 and an apex S1, S2. This surface 411b, 421b is connected to a distal wall 412, 422 of the locking mobile 4 at the level of the end B1, B2, which is intended to arrive opposite the circumference or the wall 511b of the plate 511 during the additional arc of the oscillator. This distal wall 412, 422 is contained between the inner wall 411, 421 and an outer wall 413, 423 of each of the horns 410 and 420. Each outer wall 413, 423 partially defines the contour of the locking mobile 4 and extends respectively along a longitudinal direction D410, D420. In general, it may be considered that the longitudinal directions D410, D420 define the longitudinal directions of each of the horns 410, 420.

The second portions 411b, 421b constitute protuberances projecting from the inner walls 411, 421 of each of the horns 410 and 420. In order to describe these protuberances, one may consider that the horn 410, 420 has a thickness E2 at the level of the second portion 411b, 421b, in particular at the level of the ends B1, B2, measured perpendicularly to the longitudinal direction D410, D420, and the thickness E2 is strictly greater than a thickness E1 measured at the level of the first impulse portion 411a, 421a, it too measured perpendicularly to the longitudinal direction D410, D420.

In a particular construction, this thickness E2 is at a maximum at the level of the respective apices S1, S2 of the second portions 411b, 421b. It is at these apices that the contact is liable to be made between the second portions 411b, 421b and the impulse pin 511a.

In a particular construction, the thickness E2, specifically measured at the level of the apices S1, S2, is approximately equal to 1.5.E1. More generally, it may be considered that E2>E1, or even E2>1.1.E1, or even E3>1.2.E1, or even E3>1.3.E1.

On FIG. 4, it may be noted that the radius of curvature R2 is less than the radius of curvature R1. In a particular construction, R1 is in the order of 5.R2. More generally, it may be considered that R2<R1, or even 2.R2<R1, or even 4.R2<R1.

Complementarily, it may be considered that the first impulse portion 411a, 421a and the second portion 411b, 421b form a salient angle δ, i.e. strictly less than 180°, when they are viewed from the inside of the fork 400. In particular, one may construct a first tangent line T1 to the first portion 411a, 421a and a second tangent line T2 to the second portion 411b, 421b, which form a salient angle δ when these latters are viewed from the inside of the fork. In particular, the first tangent line T1 may be tangent to the first portion at the level of the point of intersection of the second tangent line T2 with the first portion. More specifically, one may define a plane of symmetry of the fork, and the second tangent line T2 may be parallel or substantially parallel to the plane of symmetry of the fork. In particular, it is again possible to construct a first tangent line T1 to the first portion 411a, 421a and a second half-line D2 passing through B1, B2, which form a salient angle δ when these latters are viewed from the inside of the fork.

In the representation illustrated by FIG. 4, wherein the second tangent line T2 is substantially parallel to a plane of symmetry P4 of the fork, the angle δ formed by T1 and T2 has a value of approximately 160°. This can in particular vary from 70° to 179° according to the respective positions of the tangent lines T1 and T2. More generally, it is possible to identify a first half-line D1 passing through at least one point of the first portion 411a, 421a and a second half-line D2 passing through at least one point of the second portion 411b, 421b, in particular B1 and B2 respectively, which form a salient angle δ when these latters are viewed from the inside of the fork.

In the configuration of the locking mobile 4 shown in FIGS. 2 to 4, the following points can be noted:
the locking mobile 4 is symmetrical with respect to the plane P4,
the locking mobile 4 is a planar component which comprises only one level,
the locking mobile 4 is devoid of a dart,
the first and second impulse input portions 41a, 41b are arranged between the first and second surface locking portions 43a, 43b,
the second portions 411b, 421b are arranged at a distance or at a radius R4 from the fourth axis of rotation A4, and the first surface locking portions 43a, 43b and/or the first and second impulse input portion 41a, 41b are arranged at a distance or at a radius R41 from the fourth axis of rotation A4, and R4>R41, preferably R4>1.4.R41, preferably R4>1.8.R41;
an angle γ is less than an angle α;
the angle γ being defined:
   between a line S3 connecting the first impulse input portion 41a to the fourth axis of rotation A4 and a line S4 connecting the second impulse input portion 41b to the fourth axis of rotation A4,
the angle α being defined:
   between a line S1 connecting the first surface locking portion 43a to the fourth axis of rotation A4 and a line S2 connecting the second surface locking portion 43b to the fourth axis of rotation A4.

Returning to FIG. 1, it may be noted that the escapement device 10 is of tangential dual impulse type. This escapement device 10 shown in FIG. 1 has the peculiarity of having an operational safety made possible by the fact that during the resting phase of FIG. 1, the locking force F incurred by the contact between the first escapement mobile 1 and the locking mobile 4 passes (or substantially passes) through the fourth axis of rotation A4 of the locking mobile 4, in particular owing to first and second surface locking portions, which are concave, shaped to offer good locking safety. Thus, during a given resting phase, the locking mobile 4 does not undergo any rocking torque, which makes it possible to obtain a stable locking position.

In the scenario of a high-intensity shock, for example when the watch undergoes a fall, the operational safety can be further improved by making provision for abutments to limit the angular track of the locking mobile 4 when the latter is normally immobilized owing to one or the other of its first and second surface locking portions.

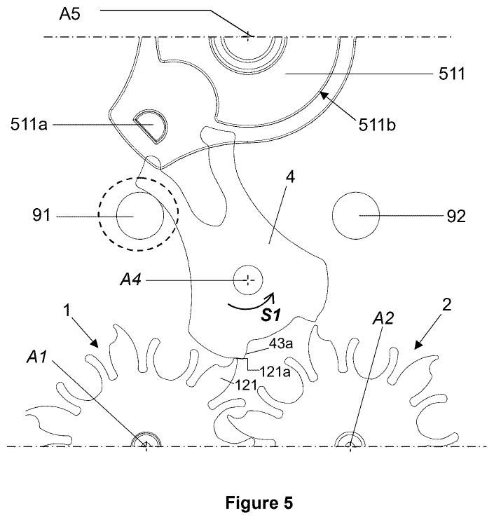

FIG. 5 shows the regulator device of FIG. 1, during a resting phase of the escapement device, following a shock leading the locking mobile to make an angular rotation in a first direction S1. In this scenario, first outer abutments taking for example the form of banking pins 91 and 92 or detent pins or abutment walls may thus be provided to limit the angular track of the locking mobile in the given first direction S1. Thus the track of the locking mobile 4 is limited in the direction of rotation S1, even in the event of an untimely shock.

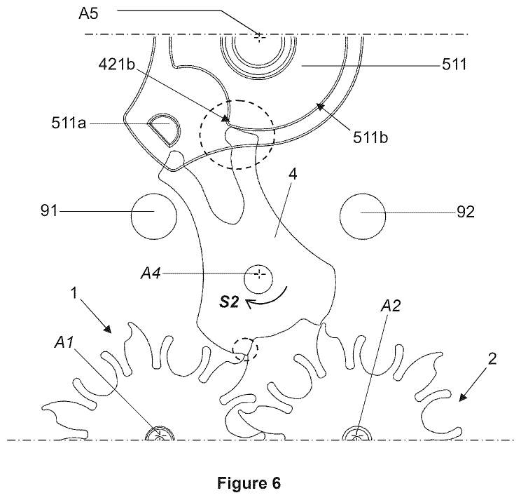

FIG. 6 shows the regulator device of FIG. 1, during a resting phase of the escapement device, following a shock leading the locking mobile to make an angular rotation in a second direction S2. In this scenario, to further improve the operational safety, one may seek to avoid a tooth of the first escapement mobile 1 normally in contact with the first surface locking portion 43a of the locking mobile 4 coming into contact with the adjacent impulse input portion, which could thus induce an untimely displacement of the locking mobile 4 ahead of a phase of disengagement from the balance 51.

For this purpose, provision is made for forming the second portions 411b and 421b, the so-called abutment portions, at the level of the free ends of each of the horns 410, 420 of the locking mobile 4. These second portions 411b and 421b have the peculiarity of being composed of ends of protuberances projecting from the inner walls of each of the horns 410, 420 in order to keep the fourth axis of rotation A4 of the locking mobile 4 as far as possible from the area of contact between the locking mobile 4 and the abutment wall 511b of the balance plate 511 (the oscillations of which are sustained by the escapement). The angular shake of the locking mobile 4 is thus minimized, and it is not possible for a locking tooth of an escapement mobile normally in contact with one of the first and second surface locking portions 43a, 43b of the locking mobile 4 to come into contact with an adjacent impulse input portion 41a, 41b. Note that for one and the same angle of the locking mobile 4, a protuberance of the horn 410, 420 will make a more significant displacement than another part of the locking mobile 4 due to its separation from the fourth axis of rotation A4 of the locking mobile 4.

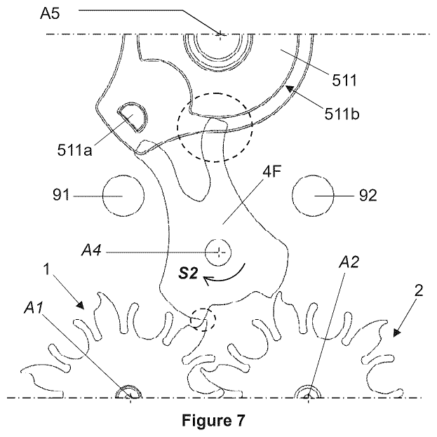

FIG. 7 shows a fictitious regulator device in the same configuration as that shown in FIG. 6, and comprising a fictitious locking mobile. By way of comparison with FIG. 6, FIG. 7 shows the escapement device 10 in the same configuration as that of FIG. 6, but with a fictitious locking mobile 4F the horns of which are each devoid of protuberances at their free ends, with an inner wall shaped solely facing the impulse function. The locking tooth or the locking surface of an escapement mobile is then able to come into contact with an impulse input portion as shown in the area surrounded by a circled in dotted lines at the bottom of the figure.

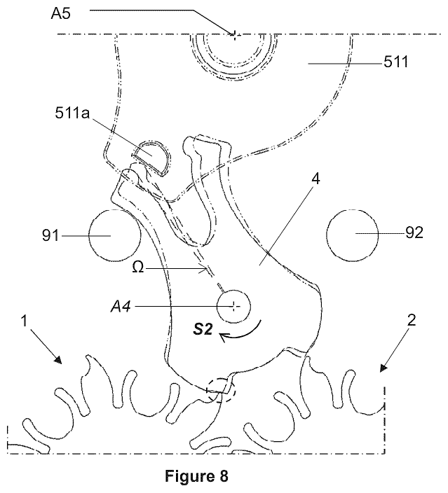

FIG. 8 shows the regulator device of FIG. 6, to show the shake of the locking mobile, particularly at the horns of the locking mobile. The second portions 411b and 421b, the so-called abutment portions, by interaction with the impulse pin 511a, also have the advantage of minimizing the shake of the horn, namely the angle Ω that is liable to be accidentally travelled by the locking mobile 4 when the pin 511a is in the phase of engagement with or disengagement from the fork 400, at any end or any beginning of a resting phase as shown in FIG. 8. Any contact between the second portions 411b and 421b, the so-called abutment portions and the impulse pin 511a makes it possible to ensure that the locking tooth or a locking surface of an escapement mobile normally in contact with one of the first and second surface locking portions 43a, 43b of the locking mobile 4 cannot come into contact with an adjacent impulse input portion 41a, 41b.

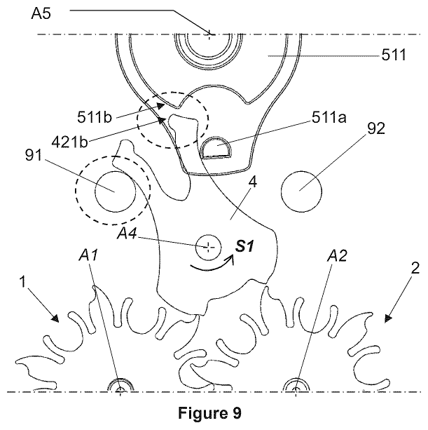

In general, the second portions 411b and 421b, the so-called abutment portions, also have the advantage of widening the horns 410, 420 at their free end and thus preventing any overbanking of the locking mobile 4, the horns 410, 420 being always able to come into contact with the wall of the balance plate during the additional arc made by the balance, or in other words when the pin of the plate is not located between the two horns. FIG. 9 shows the regulator device of FIG. 1, during a knocking of the oscillator while the escapement device is in the resting phase. The general arrangement makes it possible to guarantee a rotation of the locking mobile 4 in the first direction S1 all the way to contact with a banking pin 91.

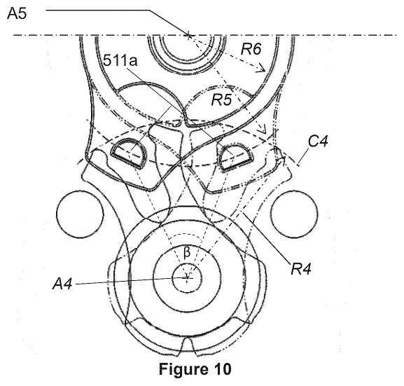

Thus, the horns 410, 420 with their protuberance replace the dart known to the prior art in its anti-overbanking function. This is emphasized by the fact that the locking mobile 4 of the escapement device 10 has a rocking angle β, in the order of 50°, much greater than that of a typical Swiss anchor escapement, which is in the order of 15°. This permits the disengagement of the impulse pin 511a from the fork 400 while allowing, where applicable, the interaction of the horns 410, 420 with the abutment wall 511b of the balance plate 511 during the additional arc of the balance 51 and more generally of the oscillator. FIG. 10 shows a detail of the regulator device of FIG. 1 to show the total rocking angle β of the locking mobile 4 occupying two successive resting positions.

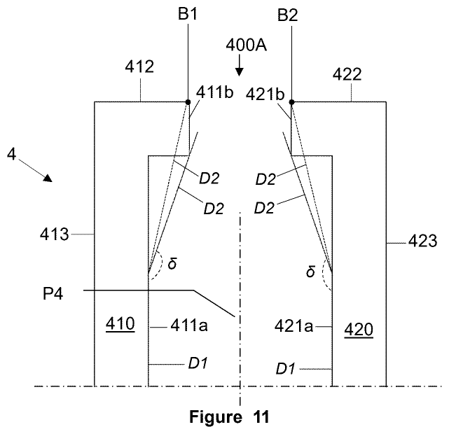

FIG. 11 shows a very simplified fork 400A of a first variant embodiment of the fork 400 of the locking mobile 4 of the regulator device of FIG. 1. In this first extremely simplified variant embodiment, it my be noted that a first half-line D1 which is colinear with the first portion 411a, 421a and a second half-line D2 which passes through a single point of the second portion 411b, 421b which may correspond to the point B1, B2 or be differentiated therefrom.

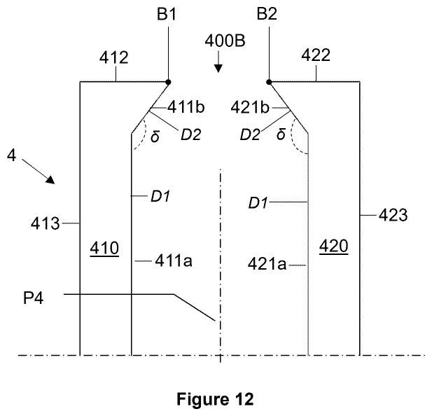

FIG. 12 shows a very simplified fork 400B of a second variant embodiment of the fork 400 of the locking mobile 4 of the regulator device of FIG. 1. In this second extremely simplified variant embodiment, one may note a first half-line Dq1 which is colinear with the first portion 411a, 421a and a second half-line D2 which is colinear with the second portion 411b, 421b and which thus passes through a point corresponding to B1, B2.

Whatever the variant under consideration and with reference to FIGS. 2, 3, 4, 11, 12, the inner walls 411 and 421, in particular the abutment means B1, B2, are symmetrical with regard to a plane P4 passing through the fourth axis of rotation A4 of the locking mobile 4. More generally, the horns 410 and 420 are symmetrical with regard to this plane P4, i.e. the walls 412 and 422, as well as the outer walls 413, 423 are also symmetrical with regard to this same plane.

Preferably, the impulse pin 511a has a half-moon shape so that it can interact as well as possible with the second portions 411b, 421b, and thus minimize the horn beat, while allowing its insertion into the fork and its interaction with one or the other of the first portions 411a, 421a and thus allow the disengagement of the balance 51 and the transmission of the impulse to this same balance during an alternation of this latter.

Under normal operation of the escapement device 10, the first portions 411a, 421a are intended to interact exclusively with the pin 511a. In the scenario of a shock of high intensity, the portions 411b, 421b are themselves intended to interact with the wall 511b of the plate by way of the abutment means B1, B2, or with the impulse pin 511a by way of their respective apex S1, S2. The outer walls 413, 423 are themselves intended to interact exclusively with banking pins 91, 92 (or alternatively detent pins or abutment walls), or with the pin 511a during a knocking of the oscillator.

Due to the specifics of the escapement device with tangential dual impulse, and particularly the implementation of two escapement mobiles, the locking mobile 4 has a significant rocking angle β, in the order of 50°. The displacement of the fork 400 is thus very large by comparison with that of a fork of a Swiss anchor, even though the format of this locking mobile 4 is particularly compact, in the order of those of the two escapement mobiles and that of the balance plate 511: the space dedicated to the escapement function in a watch can thus be reduced.

In the construction exemplified in particular in FIG. 10, the radius R5 separating the pin 511a from the third axis A5 of rotation of the balance corresponds or substantially corresponds to the radius R4 of the smallest circle C4 centered on the axis A4 within which the locking mobile 4 can be contained.

In a variant embodiment, it may be envisioned to elongate the body or the fork of the locking mobile 4 to maximize the displacement of the free ends of the horns 410, 420 while containing the rocking angle of the locking mobile 4.

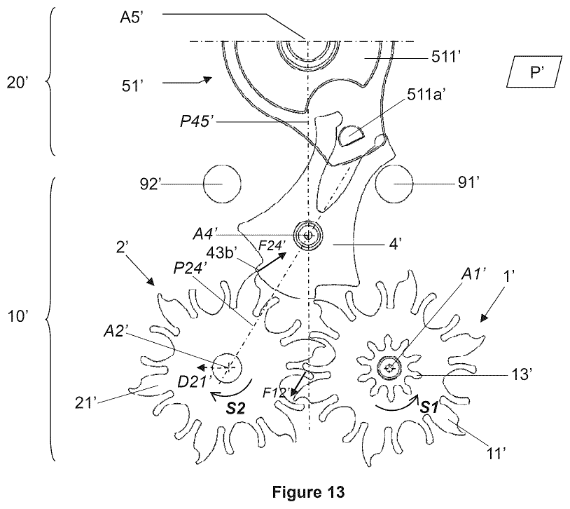

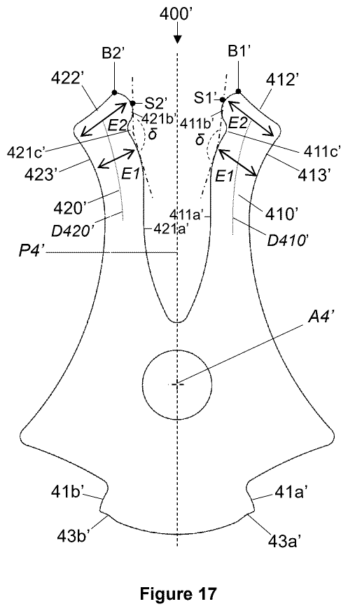

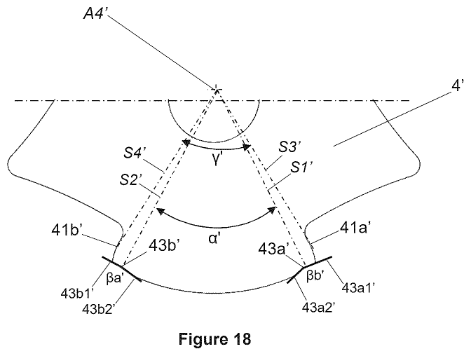

FIG. 13 shows a variant of the regulator device of FIG. 1, particularly comprising a third variant embodiment of the locking mobile of the regulator device of FIG. 1, during a resting phase of the escapement device. In this third variant embodiment, a new geometry of locking mobile is shown, which has the peculiarity of having first and second surface locking portions 43a′, 43b′ disposed between two impulse input surfaces 41a′, 41b′, as may be seen in detail in FIGS. 17 and 18.

As will be detailed below, such a locking mobile 4′ makes it possible to ensure that the reaction forces of a given escapement mobile facing, respectively, the locking mobile 4′ and the other escapement mobile are disposed on either side of a plane passing through the respective axes of rotation of the locking mobile and of the given escapement mobile.

Advantageously, such an arrangement offers a method of operation which allows for optimized control of the assembly clearances, particularly regarding the fact that the pivots of the two escapement mobiles will be displaced symmetrically (during separate operating phases) with regard to a plane passing through the respective axes of rotation of the locking mobile and of the oscillator.

This control of the assembly clearances will assist in the definition of a robust escapement device.

FIG. 13 shows a regulator device similar to that of FIGS. 1 to 10 for a movement of a timepiece, comprising:
an escapement device 10′ comprising a locking mobile 4′, a first escapement mobile 1′ and a second escapement mobile 2′,
an oscillator 20′ comprising an inertial element (here a balance) provided with a driving portion (here a pin 511a′) positioned on a plate 511′ of the balance 51, and an elastic return member (not shown) coupled to the balance (provision may typically be made for a spiral spring, or flexible elements),
two outer abutments, formed in this example by banking pins 91′ and 92′, but provision could be made for detent pins or abutment walls.

FIGS. 13 to 16 illustrate the regulator device comprising the escapement device 10′, and FIGS. 17 and 18 show in detail the third particular variant of the locking mobile 4′. It may be noted that the shape of the fork 400′ of the locking mobile 4′ is independent of the shape of the first and second surface locking portions 43a', 43b′ and/or of the first and second impulse input portions 41a′, 41b′ of this same locking mobile 4′.

FIG. 18 particularly details first and second concave surface locking portions 43a′, 43b′ which respectively consist of surfaces 43a1′, 43a2′ and 43b1′, 43b2′ forming V of an obtuse angle βa′, βb′ in the order of 165°.

This FIG. 18 particularly highlights an angle α′ separating a first line S1′ connecting the first surface locking portion 43a′ to the axis of rotation A4′ of a second line S2′ connecting the second surface locking portion 43b′ to the axis of rotation A4′.

In particular, the first line S1′ passes through the junction point connecting the surfaces 43a1′ and 43a2′ and the second line S2′ passes through the junction point connecting the surfaces 43b1′ and 43b2′. In the variant construction shown, this angle α′ is acute and is equal to approximately 55°. More generally, provision can be made for the following range of values:
50°≤α′≤70°.

This FIG. 18 also highlights an angle γ′ separating a third line S3′ connecting the first impulse input portion 41a′ to the axis of rotation A4′ from a fourth line S4′ connecting the second impulse input portion 41b′ to the axis of rotation A4′.

In particular, the third line S3′ is tangent to the first impulse input portion 41a′ and the fourth line S4′ is tangent to the second impulse input portion 41b′. In the variant construction shown, this angle γ′ is acute and is equal to approximately 65°. More generally, provision can be made for the following range of values: 60°≤γ′≤80°.

It may be noted that the locking mobile 4′ of FIG. 18 can be differentiated from the locking mobile 4 illustrated by FIG. 2 since here, the first and second concave surface locking portions 43a′, 43b′ are arranged between the first and second impulse input portions 41a′, 41b′. As a consequence, the angle α′ is less than the angle γ′ (whereas on FIG. 2, the angle α is greater than the angle γ).

With this specific shape of the locking mobile 4′, the escapement device 10′ according to FIGS. 13 to 16 has the peculiarity of being actuated by a first escapement mobile 1′ (in particular comprising a pinion 13′ driven in a first direction S1) disposed on the right of a plane P45′ passing through the respective axes of rotation of the mobile 4′ and of a balance or of an oscillator 51′, which differentiates it from the escapement device 10 of FIG. 1 equipped with a first escapement mobile 1 (comprising in particular a pinion 13 driven in a first direction S1) disposed on the left of a plane P45 passing through the respective axes of rotation of the mobile 4 and of the balance 51. The wheels 11′ and 21′ are identical to the wheels 11 and 21 of FIG. 1, with the difference that the wheels 11′ and 21′ are mounted the other way round on their respective axis A1′, A2′ with respect to the disposition of the wheels 11 and 21 on their respective axes A1, A2.

FIG. 13 illustrates the escapement device 10′ while the second escapement mobile 2′ is bearing against a second surface locking portion 43b′ of the locking mobile 4′, which incurs a reaction force F24′ directed substantially toward the axis A4′. The meshing between the first and second escapement mobiles 1′, 2′ also incurs a reaction force F12′. The vectors schematically representing these reaction forces are arranged on either side of a plane P24′ passing through the respective axes of rotation of the mobile 2′ and of the mobile 4′. By analysis of the forces applied to the second escapement mobile 2′ during this resting phase, and noting that it is locked or pressed on the second surface locking portion 43b′, it can be deduced that the mounting clearances of the second escapement mobile 2′ in relation to the second axis of rotation A2′ are taken up and allow or cause a displacement of the second escapement mobile 2′ toward the left of FIG. 13, approximately along the direction D21′ (it is possible to schematically summarize the displacement along the direction D21′ of the second escapement mobile 2′ as being a rocking or a rotation of the second escapement mobile 2′ about the bearing point of the second escapement mobile 2′ on the locking mobile 4′).

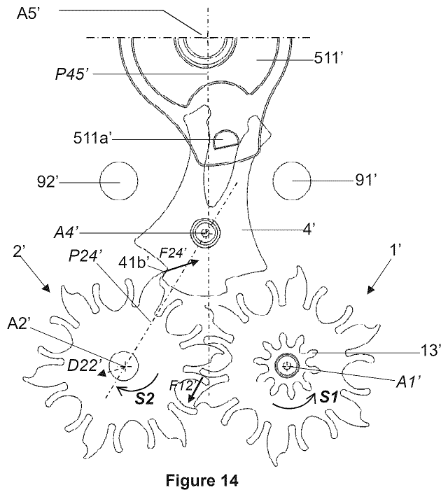

FIG. 14 illustrates the escapement device 10′ while the second escapement mobile 2′ is communicating an impulse to the locking mobile 4′ by interacting with the second impulse input portion 41b′, which incurs a reorientation of the reaction force F24′ which no longer passes through the fourth axis of rotation A4′. The vectors schematically representing the reaction forces F24′, F12′ remain arranged on either side of the plane P24′. By analyzing the forces applied to the second escapement mobile 2′ during this impulse phase, and noting on the one hand the impulse force F24′ applied to the second impulse input portion 41b′ and on the other hand the bearing force F12′, it can be deduced that the mounting clearances of the second escapement mobile 2′ in relation to the second axis of rotation A2′ are taken up and allow or cause a displacement of the second escapement mobile 2′ still toward the left of FIG. 14, approximately along the direction D22′.

Thus, any mounting clearances of the second escapement mobile 2′ in relation to the second axis of rotation A2′ are taken up and still allow or cause a displacement of the second escapement mobile 2′ still toward the left of FIG. 13 or 14 during the resting or impulse phase involving the second escapement mobile 2′.

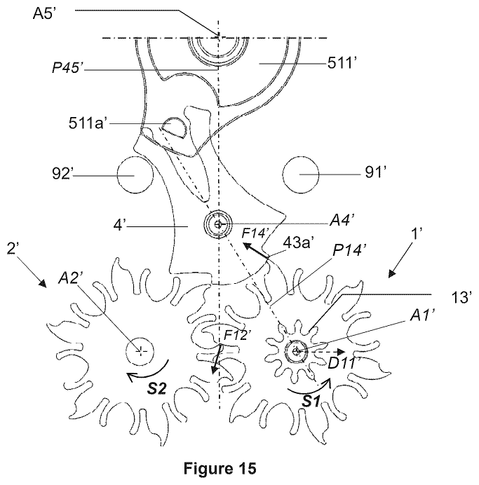

FIG. 15 illustrates the escapement device 10′ while the first escapement mobile 1′ is bearing against a first surface locking portion 43a′ of the locking mobile 4′, which incurs a reaction force F14′ directed substantially toward the fourth axis of rotation A4′. The meshing between the first and second escapement mobiles 1′, 2′ also incurs a (very low) reaction force F12′ and/or at least one stopping contact during the resting phase. The vectors schematically representing these reaction forces are arranged on either side of a plane P14′ passing through the respective axes of rotation of the mobile 1′ and of the mobile 4′. It should also be noted that the first escapement mobile 1′ is constantly subject to the driving torque of the driving gear train via the pinion 13′. By analyzing the forces applied to the first escapement mobile 1′ during this resting phase, and noting that it is locked or pressed on the first surface locking portion, 43a′, it can be deduced that the mounting clearances of the first escapement mobile 1′ relative to the first axis of rotation A1′ are taken up and allow or cause a displacement of the first escapement mobile 1′ toward the right of FIG. 15, approximately along the direction D11′ (the displacement can be schematically summarized along the direction D11′ of the first escapement mobile 1′ as being a rocking or a rotation of the first escapement mobile 1′ about the bearing point of the first escapement mobile 1′ on the locking mobile 4′, due to the driving torque applied to the first escapement mobile 1′).

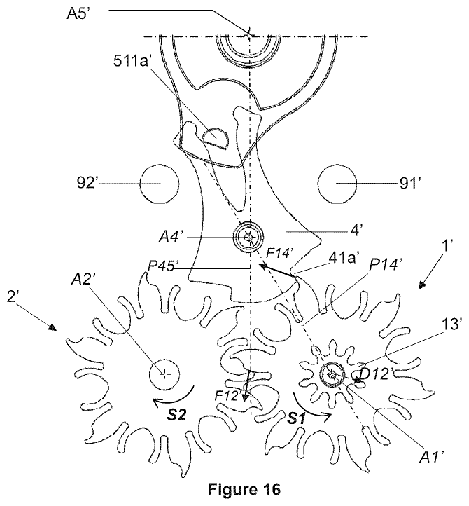

FIG. 16 illustrates the escapement device 10′ while the first escapement mobile 1′ is communicating an impulse to the locking mobile 4′ by interacting with the first impulse input portion 41a′, which incurs a reorientation of the reaction force F14′ which no longer passes through the fourth axis of rotation A4′. The meshing between the first and second escapement mobiles 1′, 2′ also incurs a (very low) reaction force F12′ and/or at least one contact during this impulse phase. It should also be noted that the first escapement mobile 1′ is constantly subject to the driving torque of the driving gear train via the pinion 13′. The vectors schematically representing the reaction forces F14′, F12′ remain arranged on either side of the plane P14′. By analyzing the forces applied to the first escapement mobile 1′ during this impulse phase, and noting on the one hand the impulse force F14′ applied to the first impulse input portion 41a′ and on the other hand the driving torque applied to the first escapement mobile 1′, it may be deduced that the mounting clearances of the first escapement mobile 1′ relative to the first axis of rotation A1′ are taken up and allow or cause a displacement of the first escapement mobile 1′ still toward the right of FIG. 16, approximately along the direction D12′.

Thus, any mounting clearances of the first escapement mobile 1′ in relation to the first axis of rotation A1′ are taken up and still allow or cause a displacement of the first escapement mobile 1′ still toward the right of FIG. 15 or 16 during the resting or impulse phase involving the first escapement mobile 1′.

Whether it is a resting phase (FIGS. 13 and 15) or an impulse phase (FIGS. 14 and 16), the escapement mobiles 1′, 2′ will be displaced symmetrically (but in separate phases) with regard to the plane P45′. In particular, the magnitude of the displacements D11′ and D21′ of the first and second escapement mobiles 1′, 2′ is the same even when the first and second escapement mobiles 1′, 2′ are successively bearing against the first and second surface locking portions 43a′, 43b′, and the orientations of the displacements D11′, D21′ are symmetrical with regard to the plane P45′. In particular, the magnitude of the displacements D12′ and D22′ of the first and second escapement mobiles 1′, 2′ is the same when the first and second escapement mobiles 1′, 2′ are successively in contact with the first and second impulse input portions 41a′, 41b′, and the orientations of the displacements D12′, D22′ are symmetrical with regard to the plane P45′.

This control of the displacements of the first and second escapement mobiles 1′, 2′ vis-à-vis their pivot bearing, and therefore of the assembly clearances, will assist in the definition of a robust escapement device. It may be noted that this manner of taking up the clearances is independent of the operational safety procured by the second portions, the so-called abutment portions, formed as protuberances or projections with respect to the first portions 411a′, 421a′, the so-called impulse portions of the horns of the fork 400′. Consequently, the locking mobile 4′ may or may not comprise a fork 400′ similar or identical to the fork 400 of the locking mobile 4 previously described in relation to FIGS. 2 to 4.

Thus, the locking mobile 4′ makes it possible to arrive at the definition of a particularly robust and, moreover, shock-resistant escapement device.

### INDUSTRIAL APPLICATION

A locking mobile according to this invention, and its manufacturing, are suitable for industrial application.

It will be understood that various modifications and/or improvements obvious to those skilled in the art may be made to the different embodiments of the invention described in this description without departing from the scope of the invention.

1. A locking mobile for a movement of a timepiece,
the timepiece movement comprising:
an escapement device comprising the locking mobile and at least one escapement mobile,
an oscillator comprising at least one inertial element equipped with a driving portion such as a tooth or a pin, and elastic return means coupled to the inertial element, the locking mobile comprising:
locking means, arranged to lock, during a resting phase, said at least one escapement mobile of the escapement device,
impulse-receiving means, arranged to receive, during an impulse phase, an impulse from said at least one escapement mobile,
a fork with two first portions, so-called impulse portions, facing one another and arranged to transmit to the driving portion of the inertial element, during the impulse phase, at least a part of the impulse received from said at least one escapement mobile, characterized in that the fork comprises two second portions, so-called abutment portions, facing one another and each projecting from one of the first portions, and each arranged to come into abutment with the inertial element, if a shock is received by the movement of the timepiece during the resting phase.

2. The locking mobile as claimed in claim 1, the fork comprising two horns each elongated along, respectively, a longitudinal horn direction, wherein each horn, along a direction transverse to the respective longitudinal horn direction, has:
a first width E1 at the level of the first portion,
a second width E2 at the level of the second portion,
and wherein E2>E1, preferably E2>1.1.E1, preferably E2>1.2.E1, preferably E2>1.3.E1.

3. The locking mobile as claimed in claim 1, wherein each of the second portion comprises at least:
a distal abutment end, formed at a free end of the fork, in particular at a free end of the horn of the fork,
a radial surface, essentially oriented along a direction normal to a pivoting direction of the locking mobile,
wherein:
the distal abutment end is arranged to come into abutment with the inertial element if a shock is applied to the movement of the timepiece during the travel of an additional ascending or descending angle by the inertial element, preferably during the travel of an additional ascending or descending angle by the inertial element during which the driving portion is not in the phase of engagement with or disengagement from the fork,
and/or
the radial surface is arranged to come into abutment with the driving portion of the inertial element if a shock is applied to the movement of the timepiece during the travel of an additional ascending or descending angle by the inertial element, preferably during the travel of an additional ascending or descending angle by the inertial element during which the driving portion is in the phase of engagement with or disengagement from the fork.

4. The locking mobile as claimed in claim 1, wherein each first portion is connected to a second portion by a third portion, so-called connecting portion, with preferably a reversal of the gradient and/or a recess arranged at the third portion.

5. The locking mobile as claimed in claim 1, wherein a first tangent line to a first portion forms with a second tangent line to the second portion arranged to project from said first portion an angle δ of less than 180° when said first portion and said second projecting portion are viewed from the inside of the fork.

6. The locking mobile as claimed in claim 1, wherein each first portion comprises, preferably moving away from an axis of rotation of the locking mobile, at least one planar surface and at least one curved surface.

7. The locking mobile as claimed in claim 1, wherein each second portion comprises at least one curved surface.

8. The locking mobile as claimed in claim 1, wherein:
the locking means and/or the impulse-receiving means are arranged at a radial distance R41 from an axis of rotation of the locking mobile,
the second portions, the so-called abutment portions, are arranged at a radial distance R4 from the axis of rotation of the locking mobile, wherein R4>R41, preferably R4>1.4.R41, preferably R4>1.8.R41.

9. The locking mobile as claimed in claim 1, characterized:
in that it is planar or formed by a planar component, and/or
in that it is devoid of a dart, and/or
in that it is made as a single part or formed by an assembly of at least two components.

10. A regulator device for a movement of a timepiece, comprising:
an escapement device comprising a locking mobile as claimed in claim 1 and at least one escapement mobile arranged to be engaged with a gear train of the timepiece movement, such as a driving gear train, to receive a driving force,
an oscillator comprising an inertial element equipped with a driving portion such as a tooth or a pin, and elastic return means coupled to the inertial element,
two outer abutments, formed for example by banking pins or by detent pins or abutment walls,
wherein, during the resting phase, the fork of the locking mobile is arranged to come into abutment with one of the two outer abutments and the driving portion in the event of a knock or knocking of the oscillator.

11. A regulator device for a movement of a timepiece, comprising:
an escapement device comprising a locking mobile as claimed in claim 1 and at least one escapement mobile arranged to be engaged with a gear train of the timepiece movement, such as a driving gear train, to receive a driving force,
an oscillator comprising an inertial element equipped with a driving portion such as a tooth or a pin, and elastic return means coupled to the inertial element,
wherein the locking mobile is mounted pivotably and has between two successive resting positions a rocking movement of an amplitude greater than 30°, preferably greater than 40°, preferably greater than 45°.

12. The regulator device as claimed in claims 10, wherein the escapement device comprises:
a first escapement mobile, mounted pivotably about a first axis of rotation, arranged to be engaged with the gear train of the timepiece movement, and comprising a plurality of first locking surfaces to interact with the locking means of the locking mobile and a first driving toothset,
a second escapement mobile, mounted pivotably about a second axis of rotation, comprising a plurality of second locking surfaces to interact with the locking means of the locking mobile and a second driving toothset engaged with the first driving toothset to transmit the driving force of the first escapement mobile to the second escapement mobile.

13. The regulator device as claimed in claim 10, wherein:
the driving portion is arranged at a radial distance R5 from the axis of rotation of the inertial element,
the second portions, the so-called abutment portions, are arranged at a radial distance R4 from the axis of rotation of the locking mobile,
wherein 0.8.R5<R4<1.2.R5 and preferably 0.9.R5<R4<1.1.R5.

14. The regulator device as claimed in claim 10, wherein:
the driving portion has a half-moon shape, and/or
the inertial element comprises a cylindrical lateral surface forming an abutment wall arranged to come into abutment with one of the two second portions, the so-called abutment portions, if a shock is received by the movement of the timepiece during the resting phase,
wherein:
the driving portion is arranged at a radial distance R5 from the axis of rotation of the inertial element wherein,
the abutment wall is arranged at a radial distance R6 from the axis of rotation of the inertial element,
wherein preferably R5>R6, preferably R5>1.2.R6, preferably R5>1.3.R6.

15. A timepiece, comprising a regulator device as claimed in claim 10.
